(19) United States
(12) Patent Application Publication
(10) Pub. No.: US 2026/0039227 A1
(43) Pub. Date: Feb. 5, 2026

(54) SINGLE RESONANCE MODE ULTRASONIC MOTOR

(71) Applicant: Seagate Technology LLC, Fremont, CA (US)

(72) Inventors: Brendon Shi Wei Leong, Singapore (SG); Xiong Liu, Singapore (SG); XiaoLei Liao, Singapore (SG); Than Zaw Myint, Singapore (SG); YiChao Ma, Singapore (SG)

(21) Appl. No.: 18/791,748

(22) Filed: Aug. 1, 2024

(51) Int. Cl. H02N 2/04; H02N 2/00

(52) U.S. Cl. CPC H02N 2/043; H02N 2/0065; H02N 2/0085

(57) ABSTRACT

An apparatus includes a hollow piezoelectric stator of symmetrical cross-section about two orthogonal axes. The stator includes first outer and inner faces, wherein the first outer face includes a first contact tip; second outer and inner faces; third outer and inner faces; fourth outer and inner faces; and eight electrode portions, wherein one of the eight electrode portions is positioned on each of said faces. A method of moving a rotor along a y-axis relative to an object is disclosed, wherein an orthogonal x-axis direction is normal to an engagement surface of the rotor at a first contact tip of a piezoelectric stator. The method includes positioning a first portion of a preload mechanism in a hollow space of the piezoelectric stator, attaching a second portion to the object, and moving the first contact tip along an elliptical path in an x-y plane to frictionally couple the engagement surface.

### SUMMARY

In one aspect, an apparatus comprises a piezoelectric stator of symmetrical cross-section about two orthogonal axes, the stator having a hollow space. The stator comprises a first outer face and a first inner face, wherein the first outer face comprises a first contact tip; a second outer face and a second inner face; a third outer face and a third inner face; a fourth outer face and a fourth inner face; and eight electrode portions, wherein one of the eight electrode portions is positioned on each of said faces.

In another aspect, a method of moving a rotor along a y-axis relative to an object is disclosed, wherein an orthogonal x-axis direction is normal to an engagement surface of the rotor at a first contact tip of a piezoelectric stator. The stator has a symmetrical cross-section about two orthogonal axes and comprises a first outer face and a first inner face, wherein the first contact tip is positioned on the first outer face; a second outer face and a second inner face; a third outer face and a third inner face; a fourth outer face and a fourth inner face; and eight electrode portions, wherein one of the eight electrode portions is positioned on each of said faces. The method comprises positioning a first portion of a preload mechanism in a hollow space of the piezoelectric stator, attaching a second portion of the preload mechanism to the object, and moving the first contact tip along an elliptical path in an x-y plane to frictionally couple the engagement surface.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1A is a perspective view of a stator of a first exemplary ultrasonic motor.

FIG. 1B is an end view of the stator of FIG. 1 (without the contact tip).

FIG. 1C is an end view of a second exemplary stator.

FIG. 1D is an end view of a third exemplary stator.

FIG. 1E is an end view of a fourth exemplary stator.

FIG. 1F is an end view of a fifth exemplary stator.

FIG. 1G is an end view of a sixth exemplary stator.

FIGS. 2A-2F show motion of the first exemplary stator over a vibration cycle in one direction; the motion is also reversible.

FIG. 3A is an end view of a first exemplary ultrasonic motor assembly including multiple stators mounted on a first exemplary pre-load mechanism, which surrounds a first exemplary rotor.

FIG. 3B is a perspective view the stator and pre-load mechanism assembly with the rotor removed, showing deflection during a normal driving operation.

FIG. 3C is a perspective view of the assembly of FIG. 3A.

FIG. 4 is a perspective view of a second exemplary ultrasonic motor.

FIG. 5 is a perspective view of a second exemplary preload mechanism configured for insertion into a hollow core of a piezoelectric stator.

FIG. 6A is a side elevation view of the preload mechanism showing directions of force application.

FIG. 6B is a side elevation view of a flexed preload mechanism after force application and fixing to an object relative to which the rotor moves.

FIG. 7 is a side elevation view of the stator and portions of the preload mechanism, with a normal force applied against a rotor.

FIG. 8A is a side elevation view of the second exemplary ultrasonic motor, illustrating a second order normal bending mode of the stator.

FIG. 8B is a top plan view of the second exemplary ultrasonic motor, illustrating a second order driving bending mode of the stator.

FIG. 9A is a perspective view of the second exemplary ultrasonic motor in a first state.

FIG. 9B is a perspective view of the second exemplary ultrasonic motor in a second, neutral state.

FIG. 9C is a perspective view of the second exemplary ultrasonic motor in a third state.

FIG. 10 is a perspective view of the second exemplary stator.

FIG. 11 is a cross-sectional view near the left end of the stator, for both the first and second embodiments, illustrating a schematic for split electrodes connecting outer and opposite inner faces of the stator.

FIG. 12 illustrates a first exemplary embodiment of electrical signal application on inner and outer faces of each of the rectangular sides of the stator of square cross section.

FIG. 13A shows a second exemplary configuration of electrical signal application for a left half of a stator, with the illustrated polarization directions.

FIG. 13B shows an exemplary electrical signal application on a right half of the stator, with the polarization scheme of FIG. 13A.

FIG. 14A shows a third exemplary electrical signal application for a left half of a stator, with the illustrated polarization directions.

FIG. 14B shows an exemplary electrical signal application on a right half of the stator, with the polarization scheme of FIG. 14A.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity.

### DETAILED DESCRIPTION

An ultrasonic motor (USM) is a type of piezoelectric motor. Two specific embodiments of an ultrasonic motor (USM) 20 are illustrated and described, and in some cases they will be differentiated by referring to the first embodiment with reference number 20a and the second embodiment with reference to number 20b. However, in many aspects, the motors are similar; descriptions of motor 20, 20a or 20b apply to all embodiments unless otherwise specified. This convention also applies to other similarly numbered elements.

It should be noted that the same reference numerals are used in different figures for the same or similar elements. All descriptions of an element also apply to all other versions of that element unless otherwise stated. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps.

It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It is contemplated that structures may be oriented otherwise.

It should also be understood that the singular forms of “a,” “an,” and “the” include plural references unless the context clearly dictates otherwise. It will be understood that, when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

A conventional USM may utilize multiple vibration modes (typically, one is an expanding mode and the other is a bending mode) to generate elliptical motion between the contact point of the stator and the rotor. These movements are strengthened, and maximum actuation speeds are attained, by aligning the oscillation frequency with the resonance frequency of the stator. However, achieving the same frequencies for two different resonance modes poses a challenge, and the frequency difference will change with different operating conditions. Thus, controlling the frequency in conventional USM's is a complex task.

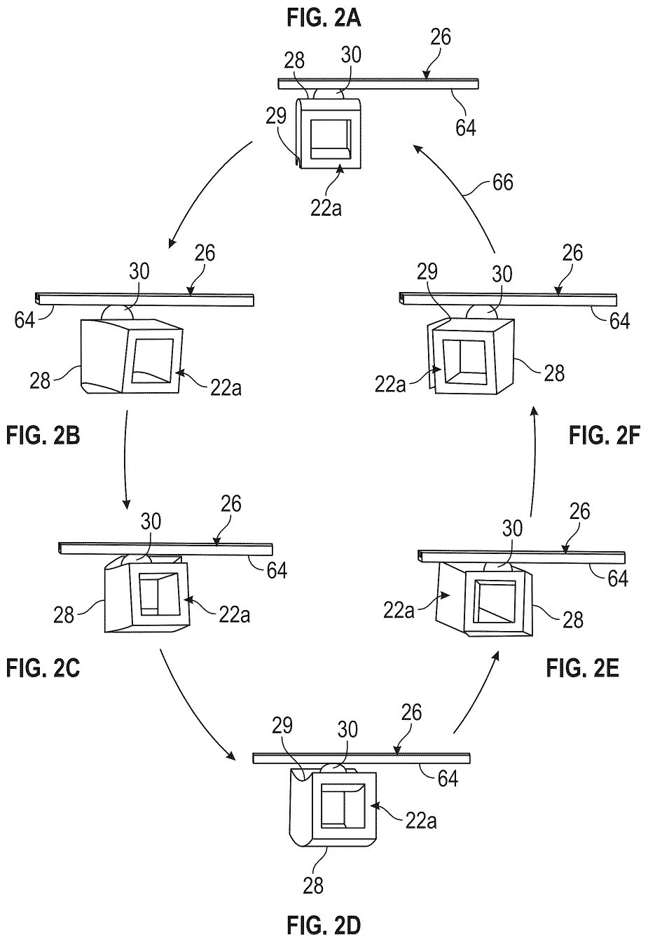

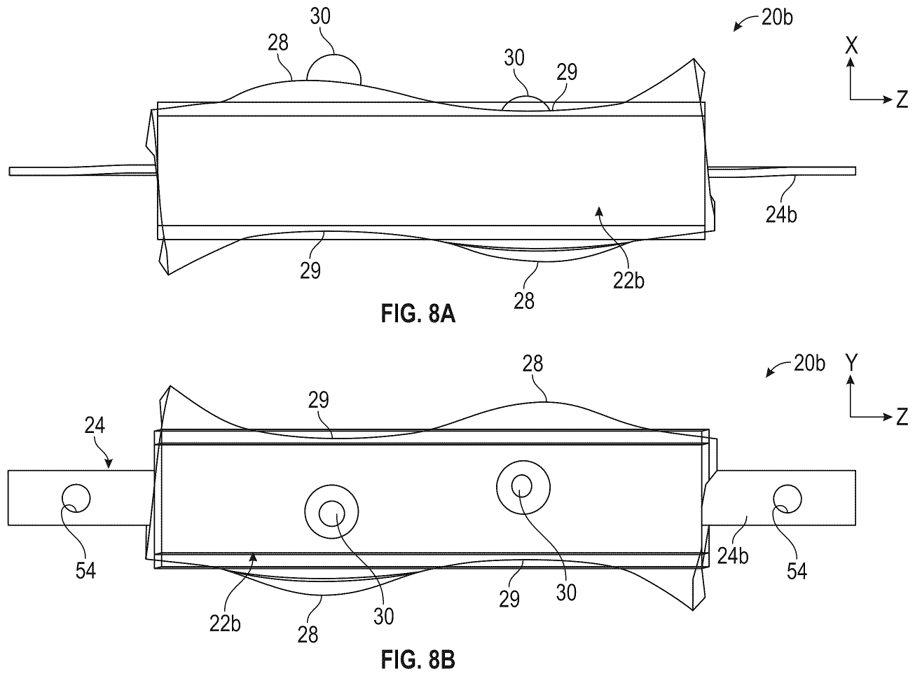

This disclosure presents a USM 20 that uses a single resonance mode. In the disclosed stator 22, there is no expanding or stretching mode, only a bending mode; thus, the disclosed ultrasonic motor 20 is a single resonance mode motor. In an exemplary embodiment, two orthogonal bending modes are used, as shown in FIGS. 2A-2D, 8A and 8B, for example. The normal bending mode moves contact tip 30 along the x axis, while the driving bending mode moves contact tip 30 along the y axis. During an actuation cycle, a combination of the normal bending mode and the driving bending mode move a contact tip in an elliptical path 66. Each of the exemplary USM's 20 includes a stator 22 and a preload mechanism 24, wherein the stator 22 is configured to provide motion to a rotor 26 through friction at contact tip 30.

In exemplary embodiments, a contact tip 30 is formed of a material such as ceramic, aluminum, zirconia or a hard plastic such as polyoxymethylene (POM). In an exemplary embodiment, each of the contact tips 30 is substantially hemispherical but can include a truncated or flattened top surface for increased surface area contact with engagement surface 64 of rotor 26. The contact tips 30 are adhered onto the top face of a piezoelectric plate 32, such as by an epoxy adhesive, for example, at antinodes of the bending resonance. In stator 22b, each of the locations of contact tips 30 in the z direction corresponds to an antinode of a second order bending vibration of the stator 22b, where the amplitude of vibration reaches a maximum value.

In an exemplary embodiment, a stator 22 is made to vibrate by the application of an electrical voltage to piezoelectric plates 32 composed of materials that have crystals that are deformed by the electrical charges. By the inverse piezoelectric effect, electrical energy is converted into mechanical energy. This effect occurs in monocrystalline materials and in polycrystalline ferroelectric ceramics. Suitable polycrystalline ferroelectric ceramics include barium titanate (BaTiO₃) and lead zirconate (PZT), for example.

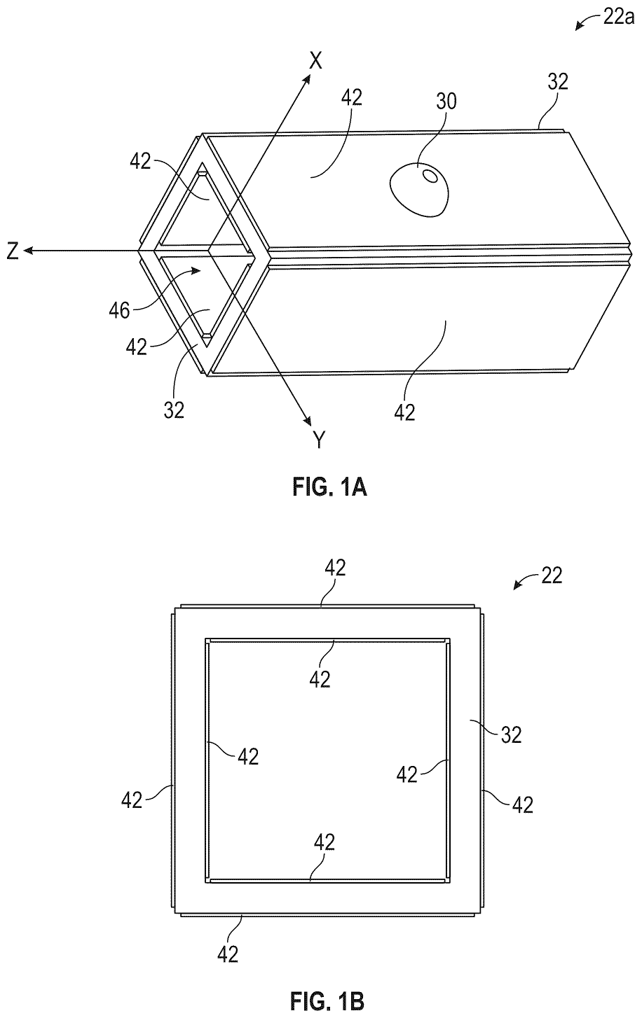

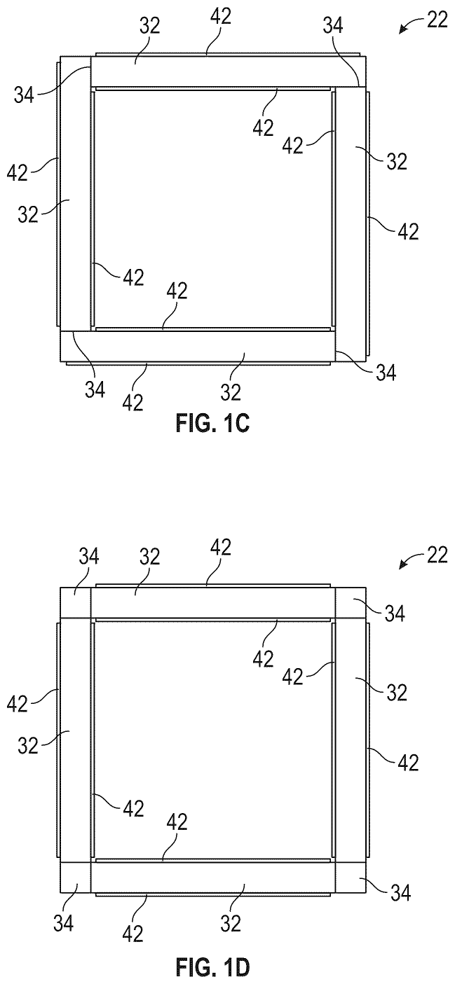

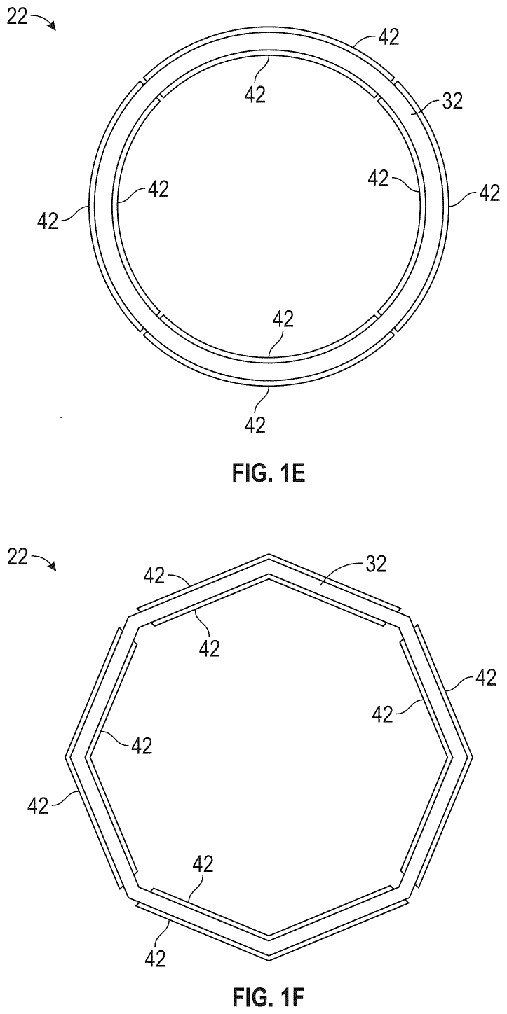

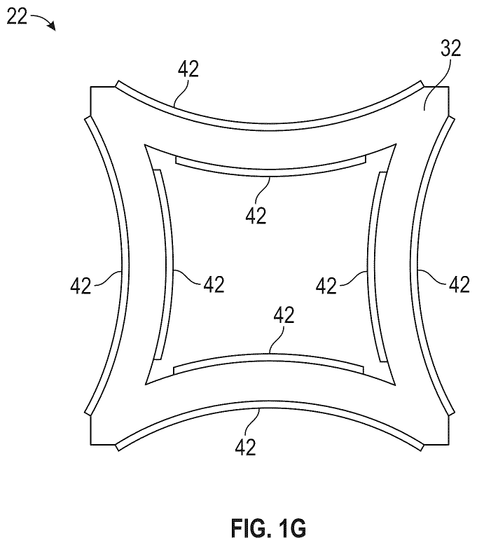

The stator 22 is frictionally coupled to rotor 26 via contact tip(s) 30, causing motion of the rotor in at least one direction in response to the vibrating stator 22. As shown in FIGS. 1A-2D, 4, 8A and 8B, the stator 22 is symmetrical in the x and y directions and thus orthogonal bending modes (x direction in FIGS. 2A, 2D and 8A and y direction in FIGS. 2B, 2C, 2E, 2F and 8B) associated with the stator 22 share the same resonant frequency. The actuation speed of a single resonance mode ultrasonic motor is proportional to the driving resonance frequency and the displacement amplitude of the bending mode.

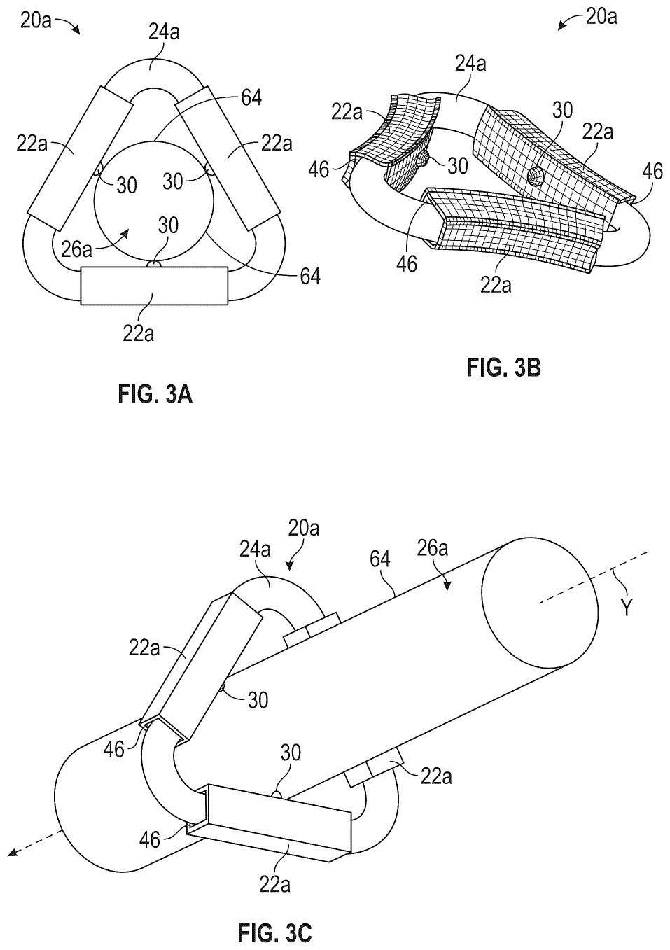

FIGS. 1A and 2A-3C illustrate a first exemplary embodiment of a USM 20a having only a first order bending mode, wherein the stator 22a has a single point 28 of convex displacement and a single point 29 of concave displacement in each of the normal (x-axis direction) and driving (y-axis direction) bending modes. In this disclosure the x-axis direction is determined for each stator 22 individually. For example, in FIGS. 3A-3C in which there are three stators 22a, each of the stators 22a has a normal (x-axis) direction that passes through contact tip 30 along the radius of the circular rotor 26a and is tangent to the cylindrical engagement surface 64 at the respective contact tip 30. It is to be understood that a first order USM 20 can also use just a single stator 22a.

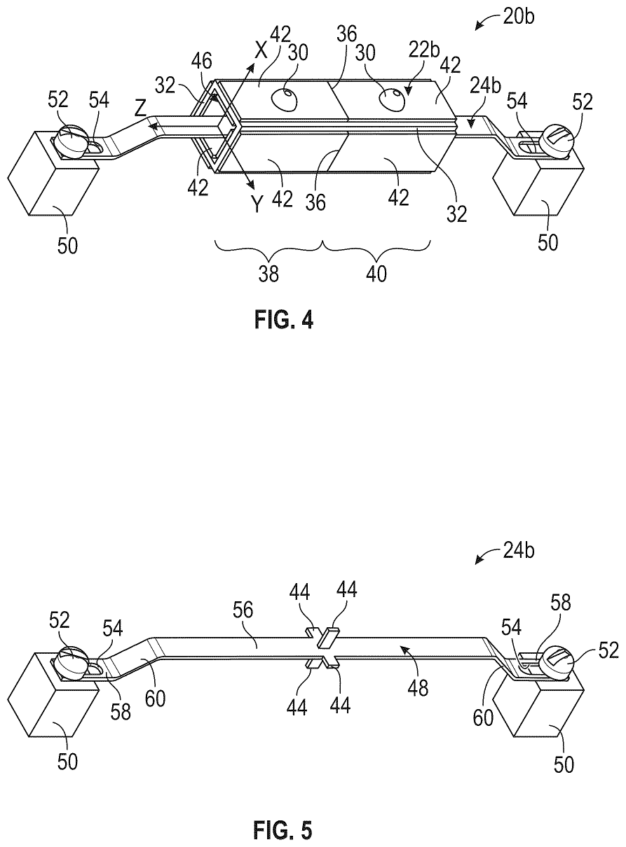

The second exemplary embodiment of a USM 20b illustrated in FIGS. 4-10 has a second order bending mode; in each of the normal bending mode illustrated in FIG. 8A and the driving bending mode illustrated in FIG. 8B, there are two points of convex displacement 28 and two points of concave displacement 29. The teachings of this disclosure can be extrapolated to construct ultrasonic motors of even higher orders, such as third order, fourth order, and higher.

Higher order bending modes occur at higher frequencies with a slight decrease in displacement amplitude. While an exemplary embodiment of the illustrated USM 20b has two contact tips 30 for actuating against a rotor 26 with a second order bending mode, it is to be understood that the teachings of this disclosure can be expanded to other ultrasonic motors having a third order bending mode with three contact tips, and higher bending mode variations. The number of points of driving displacement increases with respect to the order of the bending mode. By using a higher order bending mode (second order or higher), the number of contact points between the stator 22 and the rotor 26 increases, thereby increasing the number of actuations in the same timeframe, effectively multiplying the actuation speed.

An ultrasonic motor has a driving frequency that is beyond the human audible upper limit of about 20 kilohertz. A typical first order driving frequency is about 40 kilohertz, while a typical second order driving frequency is about 70 kilohertz, for example.

As shown in FIGS. 1A-1G and 4 for example, an exemplary stator 22 is formed with one or more piezoelectric pieces 32 made of a material such as a piezoelectric ceramic that adopts piezoelectric characteristics on a useful scale when an electric field is applied. Several different constructions of stator 22 are shown in FIGS. 1B-1G. Any of these constructions, or variations thereof, can be used in the first order stator 22a or the second order stator 22b. In FIG. 1B, the single piezoelectric piece 32 is formed as a hollow tube of square cross section; eight electrode portions 42 are attached (such as by adhesive) to the piezoelectric piece 32: one electrode portion 42 on each of the inner and outer faces of the piezoelectric piece 32. The adhesive in all constructions is preferably a flexible epoxy, for example. In an exemplary embodiment, each adhesive layer or bead 34 is an elastic member that does not interfere with shape deformation of the piezoelectric piece(s) 32. Moreover, a contact area of the adhesive layers or beads 34 is minimized to reduce potential interference with changes in shape of the piezoelectric plates 32. In FIG. 1C, four piezoelectric pieces 32 are overlapped at their ends and adhered along an overlapping portion with a layer 34 of an adhesive. In FIG. 1D, four piezoelectric pieces 32 are adhered along their non-overlapping end edges with a bead 34 of an adhesive.

While the ultrasonic motor 20 is primarily described with reference to stators 22 of square cross-sectional shape, it is to be understood that other shapes that are symmetrical about both the X-axis and the Y-axis are also suitable. For example, FIG. 1E shows a stator 22 configured with a circular piezoelectric piece 32 attached to four convex, arcuate electrode portions 42 on the outer circumference and attached to four concave, arcuate electrode portions 42 on the inner circumference. In another example, FIG. 1F shows a stator 22 configured with an octagonal piezoelectric piece 32 attached to four bent electrode portions 42 on the outer perimeter and attached to four bent electrode portions 42 on the inner periphery. It is contemplated that any symmetrical polygonal shape with a number of sides divisible by four is suitable for the piezoelectric piece(s) 32. In yet another example, FIG. 1G illustrates that variations of polygons with curved sides can also be used for the piezoelectric piece(s) 32, with electrode portions 42 on outer and inner surfaces having complementary contours. In this disclosure, a “face” of the stator 22 is considered to be a portion of piezoelectric piece 32 underlying an electrode portion 42.

For an ultrasonic motor 20, its bending resonance frequency can be adjusted by changing the length, width and hollow area 46 of stator 22. Contact tips 30 are fixed on the stator 22 to frictionally couple the stator 22 and the engagement or actuation surface 64 of rotor 26, as shown in FIGS. 3A, 3C and 7. For a higher order USM 20b, bisector 36 divides electrode portions 42 into a left section 38 and a right section 40. Each of the stator 22a, left section 38 of stator 22b, and right section 40 of stator 22b includes a contact tip 30 and eight electrode portions 42, wherein one of the electrode portions 42 is positioned on each of the outer and inner faces on four sides of piezoelectric piece(s) 32.

An exemplary USM 20 includes a preload mechanism 24. In FIGS. 3A-3C, preload mechanism 24a is configured as an elastic band. In FIGS. 4-9C, preload mechanism 24b is configured as a steel spring plate. However, a preload mechanism can have other configurations that are designed to impart a bias force of one or more contact tips 30 of the stator 22 against a rotor 26. Moreover, any configuration of a preload mechanism can be used with any embodiment of a USM 20. For example, a steel spring plate 24b can be used with the first order stator 22a, and the elastic band 24a can be used with the second order stator 22b. Moreover, any variation of stator 22 can be used with other variations of preload mechanism 24 that are not specifically illustrated. In an exemplary embodiment, the preload mechanism 24 is inserted through the hollow body of stator 22.

In an exemplary embodiment as shown in FIGS. 3A-3C, the preload mechanism is configured as an elastic band 24a that is inserted through the hollow space 46 of three stators 22a that surround a cylindrical rotor 26a. The band 24a exerts a biasing force toward the rotor 26a at each of the contact tips 30. In an exemplary embodiment, a cross sectional circumference of the band 24a is configured to substantially fill the hollow space 46.

In contrast, as shown in FIGS. 4-9C, spring 48 is configured as a thin, bent metal strip that features standoffs 44 to center the preload mechanism 24b within the hollow space 46 of stator 22. The standoffs 44 are positioned against inner faces of the hollow space 46 of stator 22 to constrain the middle nodes of the stator. In an exemplary embodiment, the stand-offs 44 have a right angle intersection configuration reminiscent of a plus-sign, though other structures can also be used. By contacting the inner faces of the piezoelectric plates 32 at bisector 36, the stand-offs 44 transfer the reaction force of the flexed steel spring 48 to the stator 22 at the interface between the contact tips 30 and the engagement surface 64 of rotor 26. The resulting friction force at the interface of each contact tip 30 and the engagement surface 64 allows the stator 22 to move the rotor 26. In exemplary embodiments, the rotor 26 is configured as a rod, rail or plate, though other configurations are possible. Further, ends 58 of steel spring 48 are fastened to base 50, which in turn can be attached to any object 51 relative to which the rotor 26 moves, to provide a load force that opposes the spring reaction force. In some embodiments, engagement surface 64 of rotor 26 can include features that assist in this frictional engagement, such as a knurled or otherwise textured surface. Any object 51 and any rotor configuration can be used with any configuration of USM 20.

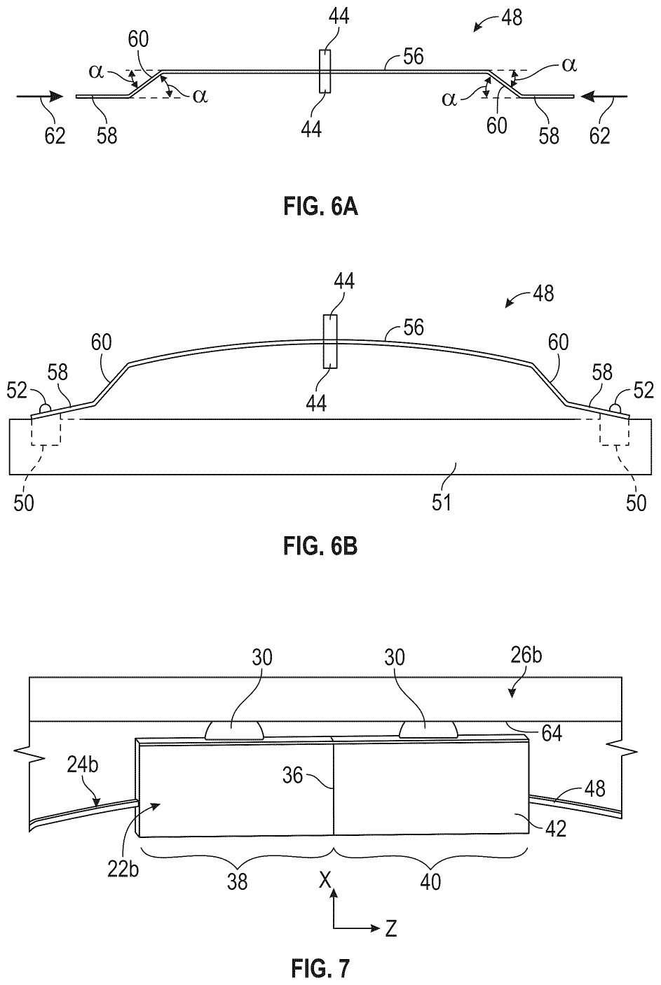

In an exemplary embodiment, opposed ends 58 of the steel spring 48 are attached to base 50 via fasteners 52 passed through apertures 54. FIG. 6A is a side elevation view of the steel spring 48 in a neutral, unloaded configuration, wherein a substantially linear central portion 56 is attached to substantially parallel linear end portion 58 by oppositely inclined bent portions 60. In the relaxed state shown in FIG. 6A, each bent portion 60 is inclined at an acute angle α to each of the central portion 56 and an end portion 58.

In an exemplary embodiment, the steel spring 48 is preloaded with force applied in side directions 62 to result in the flexed configuration of FIG. 6B. This preload, as shown in FIG. 7, results in an upward force along direction x, thereby pushing the stator 22 and its contact tips 30 against an engagement surface 64 of rotor 26. This enhances the frictional interaction between the contact tips 30 and the engagement surface 64, thereby optimizing motor performance. The steel spring 48 is maintained in the flexed configuration of FIG. 6B by tightening of fasteners 52 to maintain compression of the end portions 58 against respective bases 50 or directly against object 51, which can integrally have threaded bores. In an exemplary embodiment, each fastener 52 is a threaded screw that is held in a tightened configuration within complementary threaded bores of base 50. The preload force can be adjusted by moving the fastener 52 within each slotted aperture 54 before tightening. The selected flexed position of spring plate 48 is locked by compressing the fastening screws 52 against the base 50 with the spring ends 58 compressed therebetween. While base 50 is illustrated as having two separate portions, it is to be understood that in practice these portions are fixed in relation to each other (such as when attached to object 51) so that the flexed configuration of steel spring 48 in FIG. 6B is maintained during operation of the USM 20. In FIG. 6B, stator 22 is not shown so that the flexed configuration is visible; however, it is to be understood that preload mechanism 24b is inserted into stator 22 (see FIG. 7) before fixing its flexed configuration to object 51 in an exemplary method of use.

Referring to FIGS. 2A-2F and 8A-9C, in operation, each contact tip 30 vibrates in an elliptical path 66, thereby moving the rotor 26. Thus, the preload mechanism 24 pushes the stator 22 against the rotor 26 with a predetermined normal force in direction x. The elastic compression of preload mechanism 24a and the induced flex of preload mechanism 24b each push the stator 22 and its contact tip(s) 30 toward the engagement surface 64 to improve response time. This elliptical path 66 results from the combined orthogonal bending modes in the x and y axes. Motion of a contact tip 30 along the elliptical path 66 can follow the directional arrows as illustrated or the elliptical motion can be reversed from the illustrated direction by changing the electrical voltage application to the exciter electrodes 42.

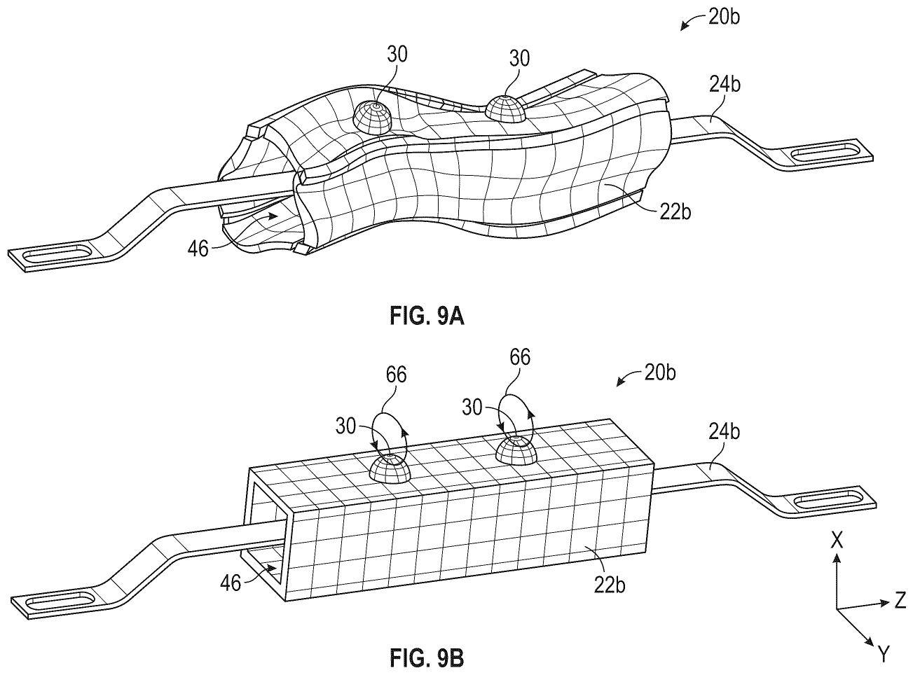

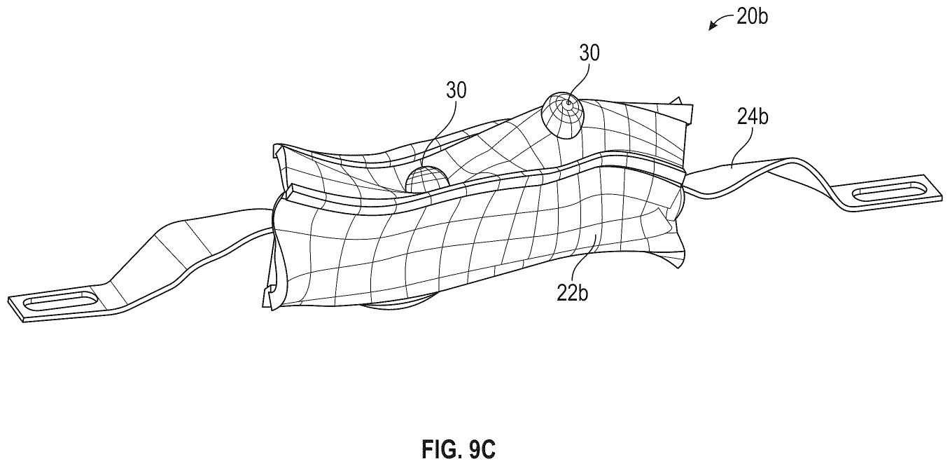

FIGS. 2A-2F and 8A-9C show motion of the contact tips 30 when electric voltage is applied to each of the electrode portions 42. FIGS. 2A-2F show one oscillation cycle of elliptical motion 66 of the first order orthogonal bending modes of stator 22a. FIG. 8A shows the second order bending mode of stator 22b in the x (normal) direction. FIG. 8B shows the second order bending mode of stator 22b in the y (driving) direction. It is to be understood that in an oscillation cycle, the left contact tip 30 would also be displaced below the neutral position (shown by the straight lines) and the right contact tip 30 would be displaced above the neutral position in the x direction. Referring to FIGS. 8A-9C, with a second order bending mode, the body of stator 20 has two bends along the longitudinal axis z and thus two convex points of displacement 28 and two concave points of displacement 29 along the z axis at the location of each contact tip 30. Straight reference lines showing the neutral, rectangular configuration of FIG. 9B are superimposed on FIGS. 8A and 8B to illustrate the extent of deformation in each of the two orthogonal directions.

The illustration of motion of the contact tips 30 is exaggerated for ease of understanding. Actuation of the piezoelectric stator 22 results in the contact tips 30 moving along elliptical trajectories 66 against the engagement surface 64 of rotor 26. The direction of motion will be reversed by switching the direction of the phase angle difference of the sine wave voltage (i.e., changing the polarity of the voltage). The motion trajectory 66 of contact tips 30 can be controlled by the amplitude and/or frequency of the electrical voltage drive signals. The term “ultrasonic” means that the frequency of oscillation lies outside of the audible frequency range for humans. Thus, the ultrasonic piezoelectric actuator motor 20 operates noiselessly. Additional advantages of an ultrasonic piezoelectric actuator motor over other types of actuators include low mass, small size, case of assembly, low power consumption, and low heat generation, which are obtainable by its operation at resonance, which is energetically more favorable than quasi-static operation.

FIGS. 9A-9C show that the orthogonal bending modes in the x and y directions combine to produce elliptical motions 66 of each of the contact tips 30 in the x-y plane in directions 66 shown by the illustrated arrows or in the opposite directions, depending on the voltage application. Each of the contact tips 30 alternately moves upward and downward in the x directions, as well as forward and backward in y direction as illustrated, thereby doubling the actuation contacts against rotor 26 as compared to a motor that has only a single order motion with a single contact tip. While particular directions on a cartesian coordinate system are illustrated and discussed with respect to the illustrated embodiments of a USM 20, it is to be understood that the USM can be oriented differently than illustrated, so that rather than providing reciprocal horizontal motion, the rotor 26 can be made to move vertically or at any other orientation. Thus, in a practical implementation, any structure can be configured as rotor 26 to be moved substantially linearly in either the positive or negative direction with respect to another structure 51 fixed to base 50 or preload mechanism 24.

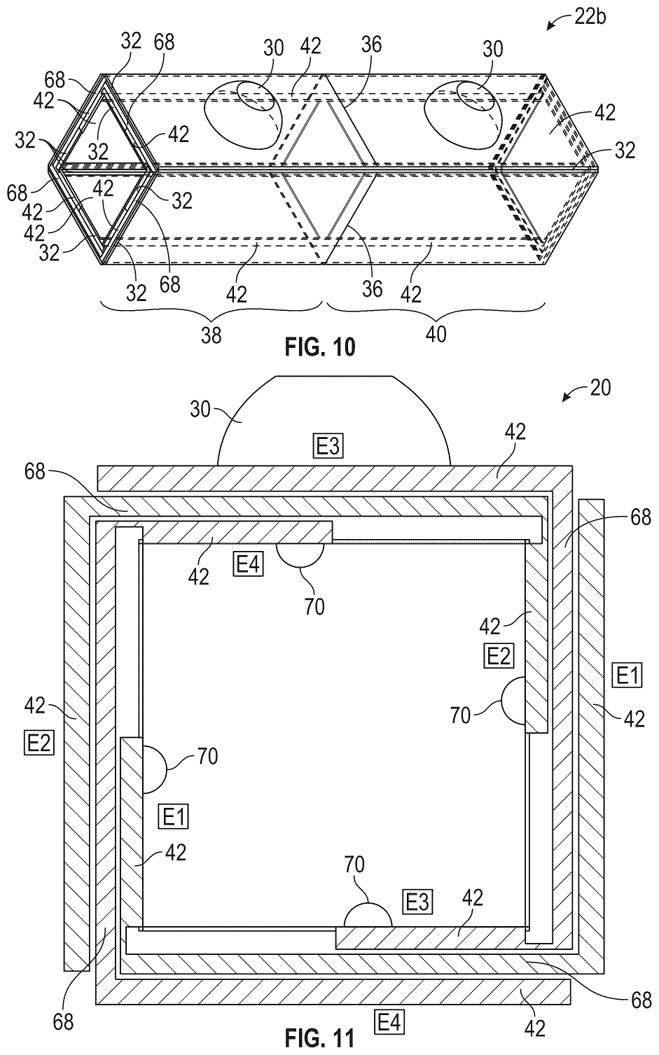

FIG. 1A is an isometric view of a first order stator 22a showing that each of the inner and outer faces of the piezoelectric piece 32 has an exciter electrode portion 42. Thus, there are eight electrode portions 42. FIG. 10 is an isometric view of a second order stator 22b, showing that each of the inner and outer faces of the piezoelectric piece 32 on the left section 38 has an electrode portion 42; similarly, each of the inner and outer faces of the piece 32 of the right section 40 has electrode portions 42 positioned thereon. Accordingly, there are sixteen electrode portions 42, with eight electrode portions 42 on the left section 38 and eight of the electrode portions 42 on the right section 40.

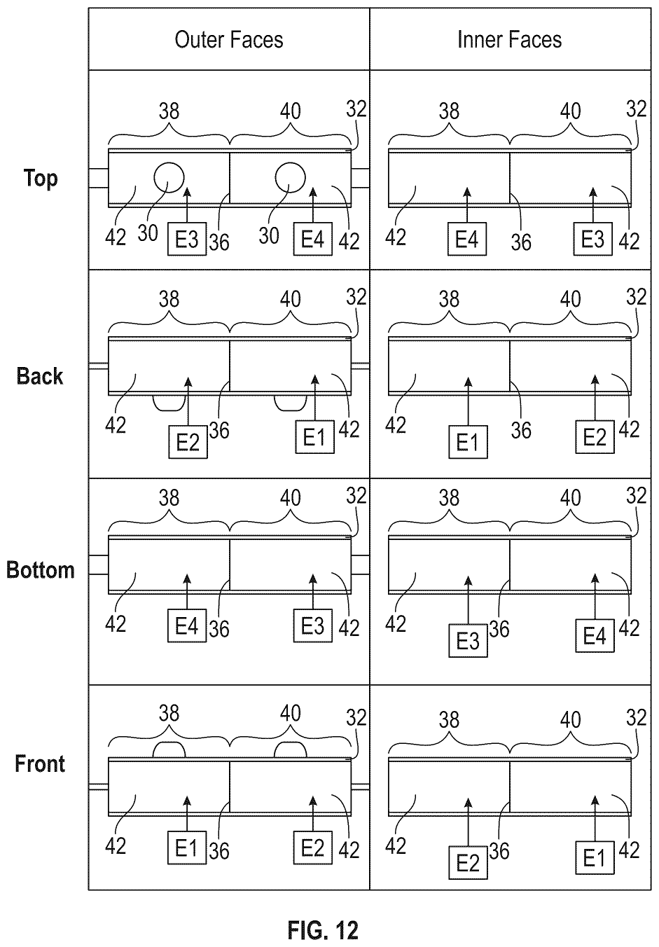

Ordinarily, these sixteen electrode portions 42 would have sixteen electrical wire leads, with one lead connected to each of the respective electrode portions 42. However, sixteen electrical leads for such a compact stator 22b can become cumbersome and can even affect modal frequencies due to the added soldered mass. To address such a challenge, FIG. 11 illustrates an exemplary configuration of electrical connections near an end of the stator 22a shown in FIG. 1 or the stator 22b shown in FIG. 10. To assist in distinguishing between the inner and outer faces of the piezoelectric plates 32 and the electrode portions 42 positioned thereon, we can refer to the electrical signals to be applied to each of these electrode portions 42 in an exemplary implementation. Referring to FIG. 12, the chart shows the electrical signals that are applied to each of the electrode portions 42 on each of the outer and inner faces of the top, back, bottom, and front piezoelectric piece(s) 32 of second order stator 22b of FIG. 10. It is to be understood that the first order stator 22a of FIG. 1A can be electrified as illustrated for either left section 38 or right section 40. It is to be understood that FIG. 11 is a schematic to show relationships but is not a realistic view; in FIG. 11, electrode portions 42, interconnecting traces 68 and wires 70 are enlarged to show their paths on and around plates 32, which are not shown for simplicity.

In an exemplary implementation, four different electrical signals can be applied as follows:

$${E}_{1} = + V sin ( 2 π ft )$$

$${E}_{2} = - V sin ( 2 π ft )$$

$${E}_{3} = + V cos ( 2 π ft )$$

$${E}_{4} = - V cos ( 2 π ft )$$

It should be understood that E₁ and E1 refer to the same signal; E₂ and E2 refer to the same signal; E₃ and E3 refer to the same signal; and E₄ and E4 refer to the same signal. Using the exemplary electrical signals of left section 38 in FIG. 12, we refer to the end view of FIG. 11. As illustrated, the electrode portions 42 that are both excited by the electrical signals E₁ are connected by an interconnecting trace 68. Similarly, the electrode portions 42 that are both excited by the electrical signals E₂ are connected by an interconnecting trace 68; the electrode portions 42 that are both excited by the electrical signals E₃ are connected by an interconnecting trace 68; and the electrode portions 42 that are both excited by the electrical signals E₄ are connected by an interconnecting trace 68. The two electrode portions 42 on opposite plates 32 that are electrically interconnected by a trace 68 share a common electrical signal (one of E₁, E₂, E₃ or E₄, designated in the drawings as E₁, E₂, E₃, E₄, respectively). Since both E₁ electrode portions 42 are interconnected, they are effectively electrified by a single wire lead 70; similar teachings apply to the E₂, E₃ or E₄ electrode portions. Thus, only four wire leads 70 are needed to supply the four different electrical signals (E₁, E₂, E₃ or E₄) to the left section 38 or to the first order stator 22a. Accordingly, in a second-order stator 22b, only eight wire leads 70 are used for imparting the second order bending vibrations. Four wires 70 send electrical input to the eight electrode portions 42 for the left section 38; another four wires 70 send electrical input to the right section 40, amounting to eight wires 70 for the second order stator 22b. These teachings can be extended for even higher order stators, in which the number of wires 70 equals four times the order of the bending mode (12 wires for a stator with a third order bending mode, 16 wires for a stator with a fourth order bending mode, and so on).

In an exemplary embodiment, the stator 22 is symmetrical in the x and y directions. In exemplary embodiments, each of the four piezoelectric plates 32 has the same dimensions, and the four plates 32 are arranged to form a hollow tube of square cross-section. As shown in FIGS. 2A-2D, 8A and 8B, the bending modes in the x and y axes share the same mode shape and frequency. As shown in FIGS. 2A, 2D and 8A, vibration in the x axis is a result of the normal mode, while in FIGS. 2B, 2C, 2E, 2F and 8B, vibration motion in the y axis is a result of the driving mode. The y axis motion is referred to as the driving mode because the rotor 26 will move in the positive and negative y directions.

Referring to FIG. 11, to initialize the driving mode (y axis motion) in an exemplary method, electrical signals E₁ and E₂ are applied to respective electrode portions 42 via wire leads 70 by inputting a sine/square wave signal at the bending mode frequency. Meanwhile, the normal mode (x axis motion) is initialized when electrical signals E₃ and E₄ are applied to excite the respective electrode portions 42 via their wire leads 70 by applying a signal at the same frequency with a phase difference.

Referring to FIGS. 2A-3C and 9A-9C, as the stator 22 vibrates in resonance, the contact tip(s) 30 undergo the elliptical motion 66, which produces a linear motion in the forward and backward directions y, tangential to the displacement ellipse 66. By changing the polarity of the applied voltages, the displacement direction can be changed. Referring to FIGS. 3A-3C, the plurality of stators 22a are connected by elastic ring 24a and positioned so that their contact tips 30 press against the cylindrical engagement surface 64 of rotor 26a, causing the rotor 26a to slide along the y axis. By attaching the pre-load mechanism 24 directly or indirectly to any structure 51, rotor 26a can be actuated along the y axis with respect to the structure.

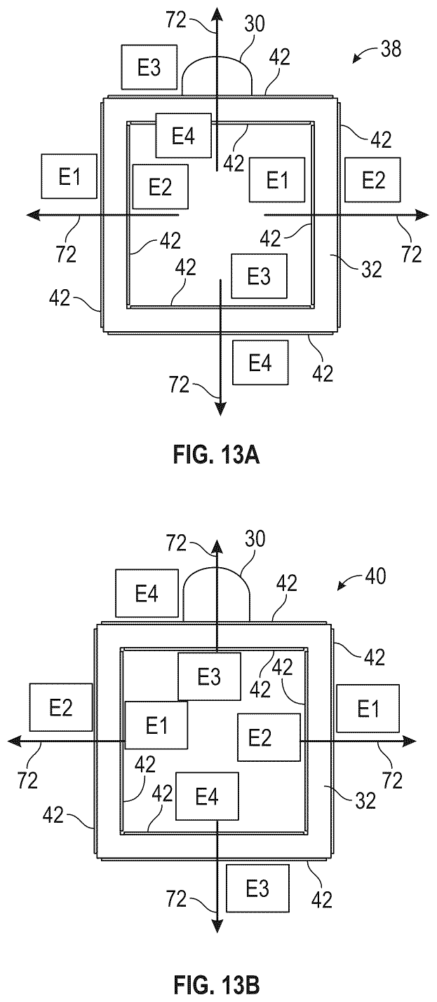

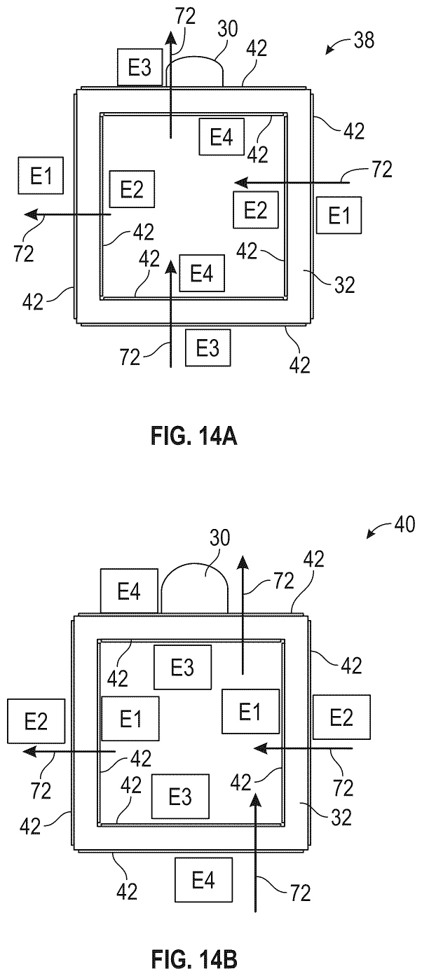

FIGS. 13A and 13B show a first exemplary excitation scheme with the indicated electrical signals for a stator 22b in which the left section 38 and right section 40 have polarization directions 72 as indicated. In an exemplary embodiment, each of the piezoelectric plates 32 is polarized in a direction of its thickness, as shown by arrows 72. These electrical signal applications are especially suitable for a stator 22 or section 38/40 having split electrodes as shown in FIG. 11. FIGS. 14A and 14B show a second exemplary excitation scheme with the indicated electrical signals for a stator 22b in which the left section 38 and right section 40 have polarization directions 72 as indicated. Any of these excitation schemes could also be used for the first order stator 22a of FIGS. 1A and 2A-3C. In exemplary embodiments, the two electrical signals applied to the opposed inner and outer faces of a plate 32 are opposite in direction but of the same phase.

In an exemplary embodiment of the second order stator 22b, the voltage polarity of the applied electrical signal is split in the z direction by bisector 36 so that on any single face of piezoelectric plate 32, the voltage polarity on the left side of the bisector 36 is opposite of the voltage polarity on the right side of bisector 36. In an exemplary embodiment, the actuation is based on excitation of the piezoelectric plates 32 in a resonance mode of a two-dimensional standing extension wave.

Exemplary, non-limiting embodiments of an apparatus and method are described. In one aspect, an apparatus 20 comprises a piezoelectric stator 22 of symmetrical cross-section about two orthogonal axes, the stator 22 having a hollow space 46. Referring to FIGS. 1A and 4 for example, the stator 22 comprises a first outer face and a first inner face, wherein the first outer face comprises a first contact tip 30; a second outer face and a second inner face; a third outer face and a third inner face; a fourth outer face and a fourth inner face; and eight electrode portions 42, wherein one of the eight electrode portions 42 is positioned on each of said faces of piezoelectric plates 32.

In an exemplary embodiment, referring to FIG. 11 for example, the eight electrode portions 42 comprise a first split electrode having two first electrode portions 42 (such as those receiving signal E₃), wherein one of the two first electrode portions is positioned on the first outer face and the other of the two first electrode portions is positioned on the third inner face. In an exemplary embodiment, a second split electrode has two second electrode portions 42 (such as those receiving signal E1), wherein one of the two second electrode portions is positioned on the second outer face and the other of the two second electrode portions is positioned on the fourth inner face. In an exemplary embodiment, a third split electrode has two third electrode portions 42 (such as those receiving signal E4), wherein one of the two third electrode portions is positioned on the third outer face and the other of the two third electrode portions is positioned on the first inner face. In an exemplary embodiment, a fourth split electrode has two fourth electrode portions 42 (such as those receiving signal E2), wherein one of the two fourth electrode portions is positioned on the fourth outer face and the other of the two fourth electrode portions is positioned on the second inner face.

In an exemplary embodiment, a first wire 70 electrically connects the electrode portion of the first outer face and the electrode portion of the third inner face (such as via interconnecting trace 68); a second wire 70 electrically connects the electrode portion of the second outer face and the electrode portion of the fourth inner face (such as via interconnecting trace 68); a third wire 70 electrically connects the electrode portion of the third outer face and the electrode portion of the first inner face (such as via interconnecting trace 68); and a fourth wire electrically connects the electrode portion of the fourth outer face and the electrode portion of the second inner face (such as via interconnecting trace 68).

In an exemplary embodiment, a preload mechanism 24 is disposed at least partially within the hollow space 46. In an exemplary embodiment as shown in FIGS. 4-9C, the preload mechanism 24b comprises a spring plate 48 centered (such as by stand-offs 44) in the hollow space 46 with opposed ends 58 of the spring plate 48 fixed at a set distance from each other (see FIG. 6B, for example). In an exemplary embodiment as shown in FIGS. 3A-3C, the preload mechanism 24a comprises an elastic band that passes through the hollow space 46. In an exemplary embodiment, the piezoelectric stator 22 is one of a plurality of piezoelectric stators 22, and the preload mechanism 24 passes through the hollow space 46 of each of the plurality of piezoelectric stators 22.

In an exemplary embodiment, the apparatus comprises a rotor 26, wherein each of the plurality of piezoelectric stators 22 frictionally engages the rotor. In an exemplary embodiment, the preload mechanism 24a is configured as an elastic band that encircles the rotor 26a.

In an exemplary embodiment as shown in FIGS. 4 and 7-14B for example, the stator 22b comprises a fifth outer face and a fifth inner face, wherein the fifth outer face comprises a second contact tip 30; a sixth outer face and a sixth inner face; a seventh outer face and a seventh inner face; an eighth outer face and an eighth inner face; and ninth, tenth, eleventh, twelfth, thirteenth, fourteenth, fifteenth, and sixteenth electrode portions 42, wherein one of the ninth through sixteenth electrode portions is positioned on each of the fifth through eighth outer or inner faces.

In another aspect, a method of moving a rotor 26 along a y-axis relative to an object 51 is disclosed, wherein an orthogonal x-axis direction is normal to an engagement surface 64 of the rotor 26 at a first contact tip 30 of a piezoelectric stator 22. The stator 22 has a square cross-section and comprises a first outer face and a first inner face, wherein the first contact tip 30 is positioned on the first outer face; a second outer face and a second inner face; a third outer face and a third inner face; a fourth outer face and a fourth inner face; and eight electrode portions 42, wherein one of the eight electrode portions is positioned on each of said faces. The method comprises positioning a first portion of a preload mechanism 24 in a hollow space 46 of the piezoelectric stator 22, attaching a second portion (such as ends 58 in FIG. 6B) of the preload mechanism 24 to the object 51, and moving the first contact tip 30 along an elliptical path 66 in an x-y plane to frictionally couple the engagement surface 64 (see FIGS. 2A-3C and 7-9C).

An exemplary method comprises applying a first electrical signal to the electrode portion 42 on the first outer face and to the electrode portion 42 on the third inner face through a shared electrical wire 70 (such as via interconnecting trace 68). Referring to FIG. 11 for example, an exemplary method comprises applying a first electrical signal (such as E3) to the electrode portion 42 on the first outer face; and applying a second electrical signal (such as E4) to the electrode portion 42 on the first inner face, wherein the first and second electrical signals have a same frequency and a same phase angle and an opposite polarity.

In an exemplary method, moving the first contact tip 30 comprises imparting a first bending mode to the piezoelectric stator 22 (such as a normal bending mode in the x direction, as shown in FIGS. 2A, 2D and 8A) and imparting a second orthogonal bending mode (such as a driving bending mode in the y direction, as shown in FIGS. 2B, 2C, 2E, 2F and 8B) to the piezoelectric stator 22. In an exemplary method, each of the first and second bending modes is a first order bending mode, as shown in FIGS. 2A-2D. In another exemplary method, each of the first and second bending modes is a second order bending mode, as shown in FIGS. 8A-9C.

In an exemplary method as shown in FIG. 6B, the preload mechanism 24b is configured as a spring plate 48, and attaching the second portion of the preload mechanism 24b to the object 51 comprises compressing a first end 58 of the spring plate 48 against the object 51. An exemplary method comprises inducing a flexed configuration to the spring plate 48 (such as by force application 62 shown in FIG. 6A) and compressing an opposed second end 58 of the spring plate 48 against the object 51 while maintaining the flexed configuration, as shown in FIGS. 6B and 7.

In an exemplary embodiment, the piezoelectric stator 22 is one of a plurality of piezoelectric stators 22, and the method comprises positioning the preload mechanism 24 within each of the plurality of piezoelectric stators 22. As shown in FIGS. 3A-3C, the preload mechanism 24a is configured as an elastic band, and the method comprises inserting the rotor 26a into the elastic band.

The illustrations of the embodiments described herein are intended to provide a general understanding of the structure of the various embodiments. The illustrations are not intended to serve as a complete description of all of the elements and features of apparatus and systems that utilize the structures or methods described herein. Features described with respect to any embodiment also apply to any other embodiment. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. All patent documents mentioned in the description are incorporated by reference.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. For example, features described with respect to one embodiment may be incorporated into other embodiments. Thus, to the maximum extent allowed by law, the scope of the present disclosure is to be determined by the broadest permissible interpretation of the following claims and their equivalents, and shall not be restricted or limited by the foregoing detailed description.

1. An apparatus comprising:
a piezoelectric stator of symmetrical cross-section about two orthogonal axes, the stator having a hollow space, the stator comprising:
a first outer face and a first inner face, wherein the first outer face comprises a first contact tip;
a second outer face and a second inner face;
a third outer face and a third inner face;
a fourth outer face and a fourth inner face; and
eight electrode portions, wherein one of the eight electrode portions is positioned on each of said faces.

2. The apparatus of claim 1, wherein the eight electrode portions comprise:
a first split electrode having two first electrode portions, wherein one of the two first electrode portions is positioned on the first outer face and the other of the two first electrode portions is positioned on the third inner face;
a second split electrode having two second electrode portions, wherein one of the two second electrode portions is positioned on the second outer face and the other of the two second electrode portions is positioned on the fourth inner face;
a third split electrode having two third electrode portions, wherein one of the two third electrode portions is positioned on the third outer face and the other of the two third electrode portions is positioned on the first inner face; and
a fourth split electrode having two fourth electrode portions, wherein one of the two fourth electrode portions is positioned on the fourth outer face and the other of the two fourth electrode portions is positioned on the second inner face.

3. The apparatus of claim 1 comprising:
a first wire electrically connecting the electrode portion of the first outer face and the electrode portion of the third inner face;
a second wire electrically connecting the electrode portion of the second outer face and the electrode portion of the fourth inner face;
a third wire electrically connecting the electrode portion of the third outer face and the electrode portion of the first inner face; and
a fourth wire electrically connecting the electrode portion of the fourth outer face and the electrode portion of the second inner face.

4. The apparatus of claim 1 comprising a preload mechanism disposed at least partially within the hollow space.

5. The apparatus of claim 4, wherein the preload mechanism comprises a spring plate centered in the hollow space with opposed ends of the spring plate fixed at a set distance from each other.

6. The apparatus of claim 4, wherein the preload mechanism comprises an elastic band that passes through the hollow space.

7. The apparatus of claim 4, wherein the piezoelectric stator is one of a plurality of piezoelectric stators, and wherein the preload mechanism passes through the hollow space of each of the plurality of piezoelectric stators.

8. The apparatus of claim 7 comprising a rotor, wherein each of the plurality of piezoelectric stators frictionally engages the rotor.

9. The apparatus of claim 8, wherein the preload mechanism is configured as an elastic band that encircles the rotor.

10. The apparatus of claim 1, wherein the stator comprises:
a fifth outer face and a fifth inner face, wherein the fifth outer face comprises a second contact tip;
a sixth outer face and a sixth inner face;
a seventh outer face and a seventh inner face;
an eighth outer face and an eighth inner face; and
ninth, tenth, eleventh, twelfth, thirteenth, fourteenth, fifteenth, and sixteenth electrode portions, wherein one of the ninth through sixteenth electrode portions is positioned on each of the fifth through eighth outer or inner faces.

11. A method of moving a rotor along a y-axis relative to an object, wherein an orthogonal x-axis direction is normal to an engagement surface of the rotor at a first contact tip of a piezoelectric stator, the method comprising:
positioning a first portion of a preload mechanism in a hollow space of the piezoelectric stator, the stator having a symmetrical cross-section about two orthogonal axes, the stator comprising:
a first outer face and a first inner face, wherein the first contact tip is positioned on the first outer face;
a second outer face and a second inner face;
a third outer face and a third inner face;
a fourth outer face and a fourth inner face; and
eight electrode portions, wherein one of the eight electrode portions is positioned on each of said faces;
attaching a second portion of the preload mechanism to the object; and
moving the first contact tip along an elliptical path in an x-y plane to frictionally couple the engagement surface.

12. The method of claim 11, comprising applying a first electrical signal to the electrode portion on the first outer face and to the electrode portion on the third inner face through a shared electrical wire.

13. The method of claim 11, comprising:
applying a first electrical signal to the electrode portion on the first outer face; and
applying a second electrical signal to the electrode portion on the first inner face, wherein the first and second electrical signals have a same frequency and a same phase angle and an opposite polarity.

14. The method of claim 11, wherein moving the first contact tip comprises imparting a first bending mode to the piezoelectric stator and imparting a second orthogonal bending mode to the piezoelectric stator.

15. The method of claim 11, wherein each of the first and second bending modes is a first order bending mode.

16. The method of claim 11, wherein each of the first and second bending modes is a second order bending mode.

17. The method of claim 11, wherein the preload mechanism is configured as a spring plate, and wherein attaching the second portion of the preload mechanism to the object comprises compressing a first end of the spring plate against the object.

18. The method of claim 17 comprising:
inducing a flexed configuration to the spring plate; and
compressing an opposed second end of the spring plate against the object while maintaining the flexed configuration.

19. The method of claim 11, wherein the piezoelectric stator is one of a plurality of piezoelectric stators, and wherein the method comprises positioning the preload mechanism within each of the plurality of piezoelectric stators.

20. The method of claim 19, wherein the preload mechanism is configured as an elastic band, and wherein the method comprises inserting the rotor into the elastic band.
